(19) United States
(12) Patent Application Publication
(10) Pub. No.: US 2024/0326398 A1
(43) Pub. Date: Oct. 3, 2024

(54) A METHOD TO PRODUCE A VENEER ELEMENT, A VENEER ELEMENT, AND A METHOD TO PRODUCE A VENEERED PANEL

(71) Applicant: Välinge Innovation AB, Viken (SE)

(72) Inventor: Rickard RITTINGE, FÖRSLÖV (SE)

(73) Assignee: Välinge Innovation AB, Viken (SE)

(21) Appl. No.: 18/576,241

(22) PCT Filed: Jul. 1, 2021
(86) PCT No.: PCT/SE2022/050670

§ 371 Date: Jan. 3, 2024

(30) Foreign Application Priority Data
Jul. 15, 2021 (SE) 2150949-2

(51) Int. Cl. B32B 37/12; B32B 3/14; B32B 21/02; B32B 21/13; B32B 21/14; B32B 37/10; B32B 37/18

(52) U.S. Cl. CPC B32B 37/12; B32B 3/14; B32B 21/02; B32B 21/13; B32B 21/14; B32B 37/10; B32B 37/18; B32B 2255/08; B32B 2255/26; B32B 2307/7376; B32B 2309/12; B32B 2317/16

(57) ABSTRACT

A method to produce a veneer element (10), including providing a first wood veneer layer (1), arranging at least one second wood veneer layer (2; 2a, 2b, 2c, 2d) with a first binder layer (21) including a first binder and starch, the first binder layer (21) being applied intermediate the first wood veneer layer (1) and said at least one second wood veneer layer (2; 2a, 2b, 2c, 2d), pressing said at least one second wood veneer layer (2; 2a, 2b, 2c, 2d) to the first wood veneer layer (1) to form a veneer element (10). Also, a veneer element, and a method to produce a veneered panel.

### TECHNICAL FIELD

Embodiments of the present disclosure relate to a method to produce a veneer element, a veneer element and a method to produce a veneered panel.

### TECHNICAL BACKGROUND

Floor coverings having a wooden surface may be of several different types. Solid wood floorings are formed of a solid piece of wood in form of a plank.

Engineered wood floorings are formed of a surface layer of wood glued to a core. The core may be a lamella core or a wood-based panel, such as plywood, MDF or HDF. The wooden surface layer may, as an example, have a thickness of 2.5-10 mm.

A wooden floor covering may also be formed by gluing a wood veneer to a core, for example, a wood-based panel, such as particleboard, MDF or HDF. A wood veneer is a thin wood layer, for example having a thickness of 0.3-1 mm. A flooring with a separate surface layer glued to a core of, for example, HDF or plywood, is more moisture stable than solid wood floorings.

Compared to solid wood and engineered wood floorings, wood veneer floorings can be produced to a lower cost and less wood resources are consumed since only a thin wood layer is used. However, a wood veneer layer cannot be sanded as a solid wood or engineered wood flooring can be.

In order to obtain certain properties or visual appearance of the wood veneer layer, the wood veneer layer may be treated before being attached to a core to form a building panel, for example a floor panel. Wood veneers may be thermo treated, smoked, and/or treated with chemicals such as ammoniac. Such treatment may make the wood veneers brittle and/or fragile and difficult to handle with modern production equipment. A fragile wood veneer may fall apart if handled with modern production equipment such as material handling equipment.

Similar problems arise with very thin wood veneers. Additionally, wood veneers from certain wood species may cause similar problems, for example wood species having high porosity.

Material handling equipment with suction cups or vacuum lifters may cause difficulties when handling thin wood veneers, wood veneers with high porosity, and/or fragile wood veneers. Instead of lifting a single wood veneer layer, an unknown number of wood veneer layers may be lifted, due thin thickness, porosity, etc., when using suction cups and/or vacuum lifters for material transportation.

### SUMMARY

It is an object of at least embodiments of the present disclosure to provide an improvement over the above described techniques and known art.

According to a first aspect of the disclosure, a method to produce a veneer element is provided. The method comprises
providing a first wood veneer layer, arranging at least one second wood veneer layer with a first binder layer comprising a first binder and starch, the first binder layer being applied intermediate the first wood veneer layer and said at least one second wood veneer layer,
pressing said at least one second wood veneer layer to the first wood veneer layer to form a veneer element.

According to an alternative to the first aspect, the first wood veneer layer is replaced by a layer comprising cellulose material, such as a paper layer, a woven layer comprising cellulose, or a non-woven layer comprising cellulose.

Said at least one second wood veneer layer may be adhered to the first wood veneer layer at least by the starch of the first binder layer.

The first binder may be a thermosetting resin. The first binder may be an amino resin.

After pressing, the first binder may be substantially uncured. By substantially uncured is understood to mean that the thermosetting binder being primary in its A- or B-state, for example, at least 90 wt % of the thermosetting binder may be in the A- or B-state. Thermosetting binders may be classified to be in either an A-, B-, or C-stage according to their extent of reaction compared to the extent of reaction at gelation. A thermosetting binder in the A-stage, the extent of reaction is less than the extent of reaction at gelation, i.e. uncured. A thermosetting binder in the B-stage is close to the gel point. A thermosetting binder in the C-stage is well past the gel point. In the A-stage a thermosetting binder is soluble and fusible. In the B-stage a thermosetting resin is still fusible but is barely soluble. In the C-stage a thermosetting binder is highly crosslinked and both infusible and insoluble. (Principles of Polymerization, George Odian, 3rd edition).

In an alternative example, the first binder may of another type than a thermosetting binder. After pressing, the first binder may not have gone through an irreversible reaction.

Pressing may be performed by applying a pressure of less than 15 bar.

Starch may be applied in an amount of 1-10 g/m², such as 2-5 g/m².

The first binder may be applied as an aqueous solution.

Said at least one second wood veneer layer may comprise a thermo-treated wood veneer.

Said at least one second wood veneer layer may have a porosity exceeding 50% as measured using mercury intrusion porosimetry (MIP). In one example, said at least one second wood veneer layer may have a porosity exceeding 60% as measured using mercury intrusion porosimetry (MIP).

Said at least one second wood veneer layer may have a thickness of less than of 0.6 mm.

Said at least one second wood veneer layer may have a thickness of less than of 0.4 mm.

Said at least one second wood veneer layer may be a sliced wood veneer.

The first wood veneer layer may have a thickness of less than 1 mm, preferably less than 0.6 mm.

The first wood veneer layer may be a rotary cut wood veneer.

A plurality of said second wood veneer layers may be applied adjacent each other on the first wood veneer layer.

Said plurality of said second wood veneer layers may be applied in a pattern on the first wood veneer layer.

The method may further comprise brushing said at least one second wood veneer layer after being adhered to the first wood veneer layer.

According to a second aspect of the disclosure, a veneer element is provided. The veneer element comprises
a first wood veneer layer,
at least one second wood veneer layer arranged on the first wood veneer layer, and a first binder layer arranged between the first wood veneer layer and said at least one second wood veneer layer, the first binder layer comprising a first binder and starch,
wherein said at least one second wood veneer layer is adhered to the first wood veneer layer at least by the starch of the first binder layer, and wherein the first binder is substantially uncured.

According to an alternative to the second aspect, the first wood veneer layer is replaced by a layer comprising cellulose material, such as a paper layer, a woven layer comprising cellulose, or a non-woven layer comprising cellulose.

By substantially uncured is understood to mean that the thermosetting binder being primary in its A- or B-state, for example, at least 90 wt % of the thermosetting binder may be in the A- or B-state. Thermosetting binders may be classified to be in either an A-, B-, or C-stage according to their extent of reaction compared to the extent of reaction at gelation. A thermosetting binder in the A-stage, the extent of reaction is less than the extent of reaction at gelation, i.e., uncured. A thermosetting binder in the B-stage is close to the gel point. A thermosetting binder in the C-stage is well past the gel point. In the A-stage a thermosetting binder is soluble and fusible. In the B-stage a thermosetting resin is still fusible but is barely soluble. In the C-stage a thermosetting binder is highly crosslinked and both infusible and insoluble. (Principles of Polymerization, George Odian, 3rd edition).

The first binder may be a thermosetting resin. The first binder may be an amino resin.

Starch may be present in an amount of 1-10 g/m², such as 2-5 g/m², in the first binder layer.

Said at least one second wood veneer layer may comprise a thermo-treated wood veneer.

Said at least one second wood veneer layer may have a porosity exceeding 50% as measured using mercury intrusion porosimetry (MIP). In one example, said at least one second wood veneer layer may have a porosity exceeding 60% as measured using mercury intrusion porosimetry (MIP).

Said at least one second wood veneer layer may have a thickness of less than of 0.6 mm.

Said at least one second wood veneer layer may have a thickness of less than of 0.4 mm.

Said at least one second wood veneer layer may be a sliced wood veneer.

The first wood veneer layer may have a thickness of less than 1 mm, preferably less than 0.6 mm.

The first wood veneer layer may be a rotary cut wood veneer.

A plurality of said second wood veneer layers may be arranged adjacent each other on the first wood veneer layer.

Said plurality of said second wood veneer layers may be arranged in a pattern on the first wood veneer layer.

According to third aspect of the disclosure, a method to produce a veneered panel is provided. The method comprises
providing a first wood veneer layer,
arranging at least one second wood veneer layer with a first binder layer comprising a first binder and starch, the first binder layer being applied intermediate the first wood veneer layer and said at least one second wood veneer layer,
pressing said at least one second wood veneer layer to the first wood veneer layer to form a veneer element in a first pressing step,
applying the veneer element on a core with a second binder layer comprising a second binder applied between the core and said at least one veneer element,
pressing said at least one veneer element and the core together in a second pressing step,
wherein in the second pressing step, the first binder and the second binder adhere the veneer element to the core to form a veneered panel.

The third aspect of the disclosure may also be formulated as a method to produce a veneered panel comprising
providing a veneer element according to the second aspect of the disclosure, or produced according to the first aspect of the disclosure,
applying the veneer element on a core with a second binder layer comprising a second binder applied between the core and said at least one veneer element,
pressing said at least one veneer element and the core together in a second pressing step,
wherein in the second pressing step, the first binder and the second binder adhere the veneer element to the core to form a veneered panel.

In the second pressing step, the first binder and the second binder may be cured, or at least substantially cured, to adhere the veneer element to the core to form a veneered panel.

After the first pressing step but prior to the second pressing step, the first binder may be substantially uncured.

By substantially uncured is understood to mean that the thermosetting binder being primary in its A- or B-state, for example, at least 90 wt % of the thermosetting binder may be in the A- or B-state. By substantially cured is understood to mean that the thermosetting binder being primary in its C-state, for example, at least 90 wt % of the thermosetting binder may be in the C-state. Thermosetting binders may be classified as A-, B-, and C-stage according to their extent of reaction compared to the extent of reaction at gelation. In an A-stage thermosetting binder, the extent of reaction is less than the extent of reaction at gelation, i.e., uncured. A B-stage thermosetting binder is close to the gel point. A C-stage thermosetting binder is well past the gel point. The A-stage thermosetting binder is soluble and fusible. The B-stage thermosetting resin is still fusible but is barely soluble. The C-stage thermosetting binder is highly crosslinked and both infusible insoluble. (Principles of Polymerization, George Odian, 3^{rd} edition).

The first binder may be a thermosetting resin. The first binder may be an amino resin. The second binder may be a thermosetting resin. The second binder may be an amino resin.

In an alternative example, the first binder may of another type than a thermosetting binder. After pressing, the first binder may not have gone through an irreversible reaction.

In an alternative example, the second binder may of another type than a thermosetting binder.

According to an alternative to the third aspect, the first wood veneer layer is replaced by a layer comprising cellulose material, such as a paper layer, a woven layer comprising cellulose, or a non-woven layer comprising cellulose.

In the first pressing step, said at least one second wood veneer layer may be adhered to the first wood veneer layer at least by the starch of the first binder layer.

Pressure applied in the second pressing step may exceed pressure applied in the first pressing step.

Pressure applied in the first pressing step may be less than 15 bar.

Pressure applied in the second pressing step may exceed 30 bar.

Starch may be applied in an amount of 1-10 g/m², such as 2-5 g/m².

Said at least one second wood veneer layer may comprise a thermo-treated wood veneer.

Said at least one second wood veneer layer may have a porosity exceeding 50% as measured using mercury intrusion porosimetry (MIP). Said at least one second wood veneer layer may have a porosity exceeding 60% as measured using mercury intrusion porosimetry (MIP).

Said at least one second wood veneer layer may have a thickness of less than of 0.6 mm.

Said at least one second wood veneer layer may have a thickness of less than of 0.4 mm.

Said at least one second wood veneer layer may be a sliced wood veneer.

The first wood veneer layer may have a thickness of less than 1 mm, preferably less than 0.6 mm.

The first wood veneer layer may be a rotary cut wood veneer.

A plurality of second wood veneer layers may be applied adjacent each other on the first wood veneer layer.

Said plurality of second wood veneer layers may be applied in a pattern on the first wood veneer layer.

The method may further comprise brushing said at least one second wood veneer layer after being adhered to the first wood veneer layer.

According to a fourth aspect of the invention, a veneered panel is provided. The veneered panel comprises a veneer element arranged on a core, wherein the veneered element is adhered to the core by a second binder layer comprising a second binder, and wherein the veneer element comprising a first wood veneer layer and at a least a second wood veneer layer arranged on the first wood veneer layer, wherein said at least one second veneer layer is adhered to the first wood veneer layer by a first binder layer arranged between the first wood veneer layer and said at least one second wood veneer layer, the first binder layer comprising a first binder and starch.

Said at least one second wood veneer layer may comprise a thermo-treated wood veneer.

Said at least one second wood veneer layer may have a porosity exceeding 50% as measured using mercury intrusion porosimetry (MIP). Said at least one second wood veneer layer may have a porosity exceeding 60% as measured using mercury intrusion porosimetry (MIP).

Said at least one second wood veneer layer may have a thickness of less than of 0.6 mm.

Said at least one second wood veneer layer may have a thickness of less than of 0.4 mm.

Said at least one second wood veneer layer may be a sliced wood veneer.

The first wood veneer layer may have a thickness of less than 1 mm, preferably less than 0.6 mm.

The first wood veneer layer may be a rotary cut wood veneer.

A plurality of second wood veneer layers may be applied adjacent each other on the first wood veneer layer.

Said plurality of second wood veneer layers may be applied in a pattern on the first wood veneer layer.

The first binder may be a thermosetting resin. The first binder may be an amino resin. The second binder may be a thermosetting resin. The second binder may be an amino resin.

### BRIEF DESCRIPTION OF THE DRAWINGS

The present disclosure will by way of example be described in more detail with reference to the appended schematic drawings, which show embodiments of the present disclosure.

FIG. 1 shows a method to produce a veneer element.

FIG. 2 shows a cross-section of a veneer element.

FIG. 3 shows a perspective view of a veneer element.

FIG. 4 shows a method to produce a veneered panel.

FIG. 5 shows a perspective view of a veneered panel.

FIG. 6 shows a brushing device.

### DETAILED DESCRIPTION

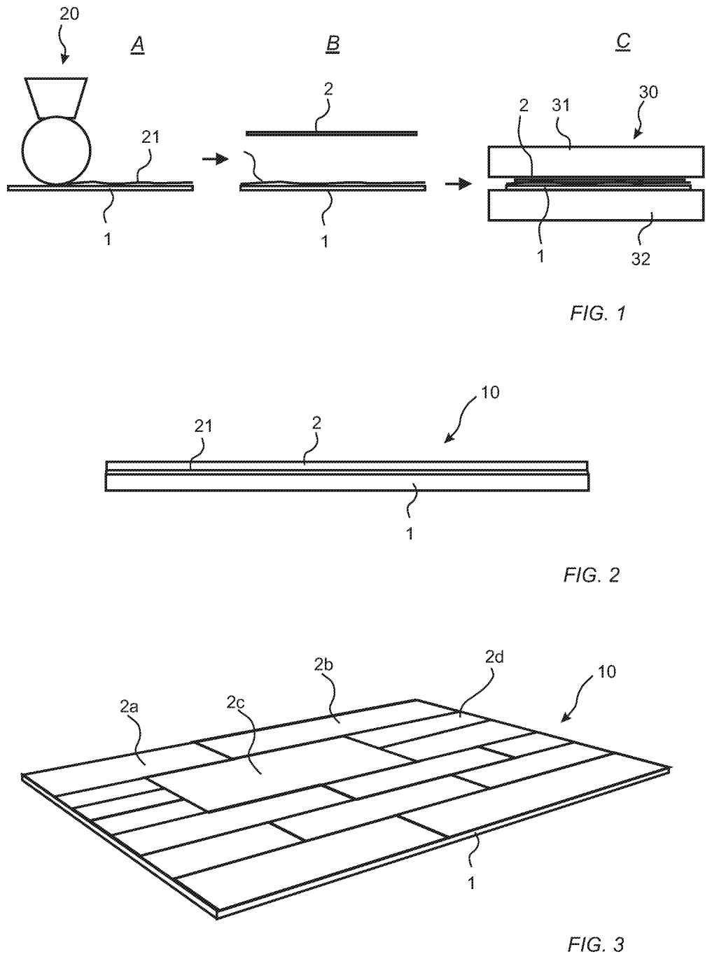

FIG. 1 shows a method to produce a veneer element 10. The method comprises providing a first wood veneer layer 1. The first wood veneer layer 1 may have a thickness in the range of 0.5-1 mm. The first wood veneer layer 1 may be a rotary cut wood veneer. The first wood veneer layer 1 may be a birch veneer layer, a poplar veneer layer, or a pine wood veneer.

A first binder layer 21 is applied on a surface of the first wood veneer layer 1, as shown in step A in FIG. 1. The first binder layer 21 comprises a first binder. The first binder may be a curable binder. The first binder may be a thermosetting binder, such as an amino resin. The first binder may be urea formaldehyde, phenol formaldehyde, melamine formaldehyde, polyurethane, polyester, emulsion polymer isocyanate (EPI), or a combination thereof. The first binder may comprise a hot melt or pressure sensitive adhesive. The first binder may be an acrylic resin or a methacrylic resin. As an alternative, the first binder may be a thermoplastic binder. The thermoplastic binder may be polyvinyl chloride (PVC), polyethylene (PE), polypropylene (PP), polyurethane (PU), polyvinyl alcohol (PVOH), polyvinyl butyral (PVB), and/or polyvinyl acetate (PVAc), or a combination thereof.

The first binder 21 may be applied in liquid form. The first binder layer 21 may be applied as liquid solution comprising the first binder. The first binder layer 21 may be applied by a roller 20, as shown in FIG. 1. As alternatives or complements, the first binder layer 21 may be applied by curtain coating, spraying, etc.

The first binder layer 21 further comprises starch, such that the liquid solution comprises both the first binder and starch. The starch may be potato starch, corn starch, rice starch, wheat starch, etc.

Starch may be mixed into the liquid solution and applied by applying the liquid solution. As an alternative or complement, starch may be applied to the first binder layer 21 after the first binder layer 21 has been applied to the first wood veneer layer 1.

The liquid solution may further comprise fillers, such as organic and/or inorganic fillers.

The first binder may be applied in an amount corresponding to 50-150 g/m².

The starch binder may be applied in an amount of 1-10 g/m², such as 2-5 g/m².

The liquid solution may be an aqueous solution comprising the first binder and the starch. The liquid solution may be applied in amount of 100-300 g/m².

The liquid solution may be an aqueous solution comprising 30-70 wt % water, such as 50 wt % water, and 30-70 wt % of the first binder, such as 50 wt % of the first binder. To the aqueous solution 1-10 wt % starch, such as 2-5 wt % starch, is added, wherein the weight percentage of starch is calculated on top of the 100 wt % aqueous solution.

A second wood veneer layer 2 is applied on the first binder layer 21, as shown in step B in FIG. 1. In examples, more than one second wood veneer layer 2 is arranged on the first binder layer 21 on the first wood veneer layer 1. If more than one second wood veneer layer 2 is arranged, the second wood veneer layers may be of the type described below with reference to the second wood veneer layer 2. After the second wood veneer layer 2 is applied, the first binder layer 21 is between the first wood veneer layer 2 and the second wood veneer layer 2.

The second wood veneer layer 2 may be or comprise an oak veneer, maple veneer, birch veneer, walnut veneer, ash veneer, and pine veneer. The oak veneer may be American oak veneer.

The second wood veneer layer 2 may have a thickness of less than 0.6 mm, such as less than 0.4 mm. The second wood veneer layer 2 may have a thickness of 0.2-0.6 mm, such as 0.2-0.4 mm.

The thickness of the second wood veneer layer 2 may be less than the thickness of the first wood veneer layer 1.

The second wood veneer layer 2 may be or comprise a thermo-treated wood veneer. Thermo-treating wood veneers may be treated at a high temperature under a period of time, such as being immersed in water having a temperature of less than 100° C., such as 40-100° C., during more than one hour, such as 1-24 hours. Time and temperature are chosen depending on the desired colour. The longer time and/or higher temperature, the darker colour may be obtained. An example of a thermo-treated wood veneer is so-called broncé wood veneers. Such thermo-treatment allows to obtain a certain visual appearance of the wood veneer. However, thermo-treatment makes the wood veneer brittle. The thermo-treatment also changes the physical structure of the wood veneer such as increasing the pore size due to the drying that occurs during thermo-treatment.

Other treatments may also make the wood veneer more brittle, and/or increasing its pore size. Such treatments may be chemical treatments, such as applying ammoniac on wood veneer, and/or smoking wood veneers.

In addition to treatments increasing the pore size of the wood veneers, porosity naturally varies between different wood species. The second wood veneer layer 2 may have a porosity exceeding 50% as measured by using mercury intrusion porosimetry (MIP), such as a porosity exceeding 60% as measured by using mercury intrusion porosimetry (MIP). Mercury intrusion porosimetry (MIP) is measured as described in “Porosity and pore size distribution of different wood types as determined by mercury intrusion porosimetry”, Plötze, M; Niemz, P, 27 Nov. 2010.

It has been discovered that wood veneers having a high porosity, for example exceeding 50%, both as naturally occurring or processed, may be difficult to handle with automatized material handling systems, for example when using vacuum lifting or suction cups. More than one wood veneer layer may be lifted by vacuum or suction cups when it is intended to handle only one wood veneer layer. The number of wood veneer layers that are handled may also vary and be unknown.

The thickness of the second wood veneer layer may also lead to similar problem when using vacuum or suction cups for material handling.

Such thin wood veneers and thermo-treated wood veneers may also be brittle, thus making the veneers difficult to handle in an industrialized process. Thermo-treated wood veneers often fall apart in a conventional process.

As an alternative to applying the first binder layer 21 on the surface of the first wood veneer layer 1 intended to face the second wood veneer layer 2, the first binder layer 21 may be applied in the above described way on a surface of the second wood veneer layer 2 adapted to face the first wood veneer layer 1.

When the second wood veneer layer 2 has been arranged on the first wood veneer layer 1, with the first binder layer 21 intermediate the first wood veneer layer 1 and the second wood veneer layer 2, the first wood veneer layer 1 and the second wood veneer layer 2 are pressed together, as shown in step C in FIG. 1. Pressing may be of the type used for glue pressing. The first wood veneer layer 1 and the second wood veneer layer 2 may be pressed together in a static press 30, as shown in FIG. 1, with upper press table 31 and lower press table 32.

The pressure applied may be less than 15 bar. The temperature may be 40-100° C. The press parameters and pressing technique may be as conventionally used for glue pressing.

The pressing in step C in FIG. 1 may be referred to a first pressing step.

After pressing, a veneer element 10 is obtained. The veneer element 10 comprises the first wood veneer layer 1, which is adhered to the second wood veneer layer 2 by the first binder layer 21.

After pressing, the second wood veneer layer 2 is adhered to the first wood veneer layer 1 at least by the starch in the first binder layer 21. The pressing parameters are chosen such that after pressing, the first binder in the first binder layer 21 is substantially uncured. By substantially uncured is understood to mean that the thermosetting binder being primary in its A- or B-state, for example, at least 90% percent of the thermosetting binder may be in the A- or B-state. Thermosetting binders may be classified to be in either an A-, B-, or C-stage according to their extent of reaction compared to the extent of reaction at gelation. A thermosetting binder in the A-stage, the extent of reaction is less than the extent of reaction at gelation, i.e., uncured. A thermosetting binder in the B-stage is close to the gel point. A thermosetting binder in the C-stage is well past the gel point. In the A-stage a thermosetting binder is soluble and fusible. In the B-stage a thermosetting resin is still fusible but is barely soluble. In the C-stage a thermosetting binder is highly crosslinked and both infusible and insoluble. (Principles of Polymerization, George Odian, 3rd edition).

Instead of obtaining adherence by the binder, for example thermosetting binder, adherence is obtained at least by starch in the first binder layer 21.

In example, the first binder may become sticky, for example, by moisture being added, and may contribute to the adherence. However, the first binder remains substantially uncured after the first pressing step.

The adherence between the first wood veneer layer 1 and the second wood veneer layer 2 may be at least 0.1 N/mm² according to EN311, such as 0.1-1 N/mm² according to EN311.

By adhering the second wood veneer layer 2 to the first wood veneer layer 1, the veneer element 10 is obtained. The first wood veneer layer 1 functions as a substrate or carrier to the second wood veneer layer 2. The first wood veneer layer 1 may reinforce the second wood veneer layer 2. The veneer element 10 may be handled as a conventional wood veneer layer in a manufacturing process, and may be handled by vacuum or suction cups with accuracy. The risk of damaging the second wood veneer layer 2 or handling more than the desired number of veneers is at least reduced by handling the veneer element 10 instead of a veneer of the type forming the second wood veneer layer 2.

A cross-section of the veneer element 10 is shown in FIG. 2. As shown in FIG. 1, the veneer element 10 comprises the first wood veneer layer 1 and the second wood veneer layer 2 adhered to the first wood veneer layer 1 at least by the starch in the first binder layer 21.

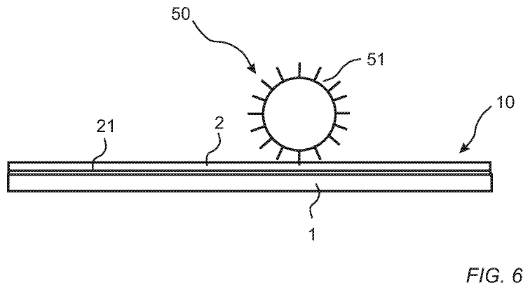

The second wood veneer layer 2 may be brushed after the first wood veneer layer 1 is adhered to the second wood veneer layer 2, as shown in FIG. 6. The second wood veneer layer 2 may be brushed by a brushing device 50 comprising a roller brush 51. The roller brush 51 may be rotating. The second wood veneer layer 2 may be deeply brushed. The second wood veneer layer 2 may be brushed into a brushing depth extending into the first wood veneer layer 1. The first wood veneer layer 1 may be partly visible after brushing.

FIG. 3 shows a perspective view of an example of the veneer element 10. In the example shown in FIG. 3, more than one second wood veneer layers 2 have been applied to the first wood veneer layer 1. The first wood veneer layer 1, the first binder layer 21, and the second wood veneer layers 2 are of the type described above.

In the example shown in FIG. 3, a plurality of second wood veneer layers 2a, 2b, 2c, 2d are arranged on the first wood veneer layer 1. The plurality of second wood veneer layers 2a, 2b, 2c, 2d are arranged on one first wood veneer layer 1. Each of the second wood veneer layers 2a, 2b, 2c, 2d have an area less than an area of the first wood veneer layer 1.

The plurality of second wood veneer layers 2a, 2b, 2c, 2d may be arranged with a gap between adjacent second wood veneer layers 2a, 2b, 2c, 2d, or may be arranged with no gap between adjacent second wood veneer layers 2a, 2b, 2c, 2d. Second wood veneer layers 2a, 2b, 2c and 2d may be overlapping, or partly overlapping.

The plurality of second wood veneer layers 2a, 2b, 2c, 2d may be arranged randomly on the first wood veneer layer 1, or may be arranged in a pattern.

In the example shown in FIG. 3, second wood veneer layers 2a, 2b, 2c, 2d have different sizes. In the example in FIG. 3, the second wood veneer layers 2a, 2b, 2c, 2d have different widths and lengths. In the example in FIG. 3, the wood veneer layers 2a, 2b, 2c, 2d together form a random pattern.

In other examples, the plurality of second wood veneer layers 2a, 2b, 2c, 2d may be arranged in a herringbone pattern, in a Dutch pattern, in a mosaic pattern, in a check pattern, etc.

In other examples, the plurality of second wood veneer layers 2a, 2b, 2c, 2d may be arranged in a pattern similar to 2-strip parquet flooring, or similar to 3-strip parquet flooring. The second wood veneer layers 2a, 2b, 2c, 2d may have an equal width but different lengths.

In examples, the second wood veneer layers 2a, 2b, 2c, 2d may have a uniform width and/or uniform length.

By arranging a plurality of second wood veneer layers 2a, 2b, 2c, 2d on the first wood veneer layer 1 to form the veneer element 10, wood veneer layers having a size less than a standard size can be used. Waste wood veneers can be used. Waste wood veneers and smaller size wood veneers can be introduced into industrialized production process thanks to being included in the veneer element 10, which may have a predetermined size.

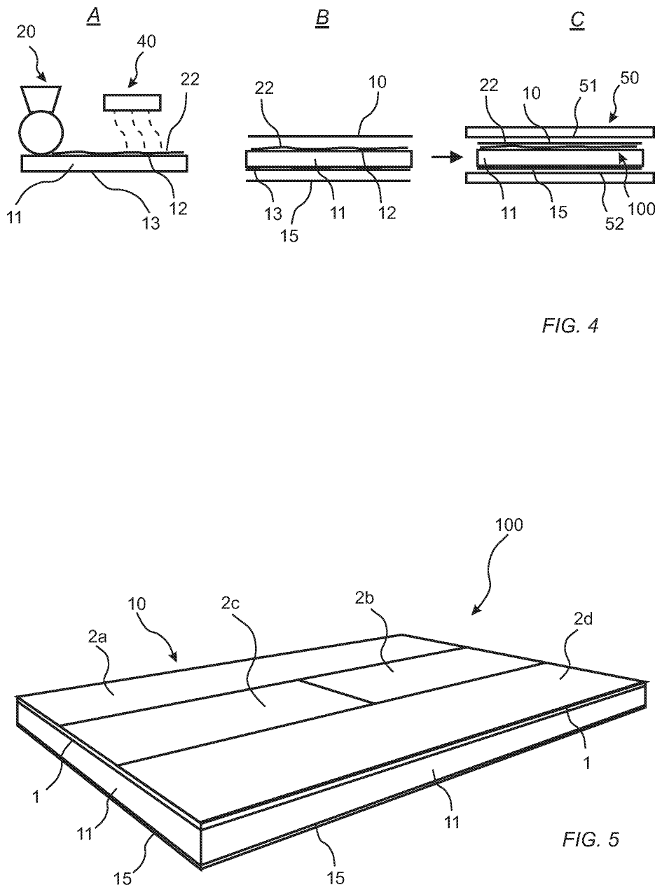

The veneer element 10 may form part of a veneered panel 100. The veneered panel 100 may be formed as shown in FIG. 4. In FIG. 4, a core 11 or substrate is provided. The core 11 may be a wood-based board such as MDF or HDF board. The core 11 may be a plywood board. The core 11 may be a lamella core. The core 11 may be a particleboard. The core 11 may be a thermoplastic board. The core 1 is preferably produced prior to the present method. The core 11 may be wood-fibre based. The core 11 may comprise a binder and fillers, such as organic or inorganic fillers.

A thickness of the core 11 may be 3-40 mm, such as 3-12 mm.

On a first surface 12 of the core 11, a second binder layer 22 is applied. The second binder layer 22 comprises a second binder. The second binder may be a thermosetting binder, such as an amino resin. The second binder may be urea formaldehyde, phenol formaldehyde, melamine formaldehyde, polyurethane, polyester, emulsion polymer isocyanate (EPI), or a combination thereof. The second binder may comprise a hot melt or pressure sensitive adhesive. The second binder may be an acrylic resin or a methacrylic resin. As an alternative, the second binder may be a thermoplastic binder. The thermoplastic binder may be polyvinyl chloride (PVC), polyethylene (PE), polypropylene (PP), polyurethane (PU), polyvinyl alcohol (PVOH), polyvinyl butyral (PVB), and/or polyvinyl acetate (PVAc), or a combination thereof.

As an alternative or complement, the second binder layer 22 may be applied on a surface of the veneer element 10 intended to face the core 11, for example, on a lower surface of the first veneer layer 1, facing away from the second wood veneer layer 2.

The second binder may be applied in liquid form. The second binder layer 22 may be applied as liquid solution comprising the second binder. The second binder layer 22 may be applied by a roller 20, as shown in step A in FIG. 4 As alternatives or complements, the second binder layer 22 may be applied by curtain coating, spraying, etc.

The liquid solution may further comprise fillers, such as organic and/or inorganic fillers.

The second binder may be applied in an amount corresponding to 50-300 g/m², such as 50-150 g/m².

The liquid solution may be an aqueous solution comprising 30-70 wt % water, such as 50 wt % water, and 30-70 wt % of the second binder, such as 50 wt % of the second binder, and, optionally, starch. The liquid solution may be applied in amount of 100-300 g/m². In one example, the liquid solution may be applied in amount of 200-600 g/m².

Optionally, the second binder layer 22 may be dried, for example in a drying device 40 as shown in step A in FIG. 4.

As an alternative to apply the second binder layer 22 is liquid form, the second binder layer 22 may be applied in powder form, for example applying the second binder in powder form. Fillers, such as inorganic fillers and/or organic fillers, may be added to the second binder in powder form, or may be applied to the second binder layer 22 after being applied on the first surface 12 of the core 11.

As alternatives or complements, the second binder may be applied as a paste, gel, foil, and/or as paper sheet comprising the second binder.

In step B in FIG. 4, the veneer element 10 produced according to the method described with reference to FIG. 1 and in FIGS. 2 and 4 is applied on the second binder layer 22. The second binder layer 22 is thereby arranged between the first surface 12 of the core 11 and the veneer element 10.

By applying the veneer element 10 instead of one or more second wood veneer 2, it is possible to use a conventional process to handle the wood veneer in the process. The veneer element 10 can be handled by vacuum or suction cups in conventional manner, unlike the second wood veneer layer.

The core 11 may have a size substantially corresponding to the size of the veneer element 10. As an alternative, more than one veneer element 10 may be arranged on the core 11 with the second binder layer 22 arranged between the first surface 12 of the core 11 and the plurality of veneer elements 10.

Optionally, a balancing layer 15 may be applied to a second surface 13 of the core 11, for example with a binder layer similar to the second binder layer 22, as shown in step B in FIG. 4. The balancing layer 15 may comprise a wood veneer layer.

In step C in FIG. 4, the assembly is pressed in a press 50 to form a veneered panel 100. Pressing parameters in step C in FIG. 4, i.e., the second pressing step, is different from the pressing parameters in step C in FIG. 1, i.e., the first pressing step.

In the process for forming the veneered panel 100, pressure applied may be at least 30 bar, such as 30-60 bar. The pressure time may be 10-60 s. The temperature applied may be in the range of 120-250° C. In one example, the pressure applied may be at least 20 bar, such as 20-60 bar.

In one example, pressing may comprise applying a pressure of at least 20 bar, such as 20-100 bar, at a temperature of at least 160° C., such as 160-250° C., during at least 10 s, such as 10-100 s.

The press 50 may be a static press, as shown in FIG. 4, with an upper press table 51 and a lower press table 52. As an alternative, a continuous press may be used.

After the pressing step C in FIG. 4, the thermosetting binder in the first binder layer 21 is substantially cured. Any thermosetting binder in the second binder layer 22 may also be substantially cured. By substantially cured is understood to mean the thermosetting binder being primary in its C-state, for example, at least 90 wt % of the thermosetting binder may be in the C-state. The C-stage thermosetting binder is highly crosslinked and both infusible insoluble. (Principles of Polymerization, George Odian, 3^{rd} edition). In one example, a thermosetting binder of the second binder layer 22 is substantially cured as well after pressing.

By curing the first binder and the second binder in during a common pressing step, a substantially homogenous binder layer is obtained. Simultaneous curing of the first binder and the second binder improves adherence between the layers and the physical properties of the binder layers. The starch in the binder layer provides the desired bonding between the first wood veneer layer 1 and the second wood veneer layer 2 prior to final pressing, and thereby allows the simultaneous curing of the first binder and second binder. After pressing in the second pressing step, the adherence between the first wood veneer layer 1 and the second wood veneer layer 2 may be at least 0.5 N/mm², such as at least 1 N/mm², according to EN311. The adherence between the first wood veneer layer 1 and the second wood veneer layer 2 may be in the range of 0.5-10 N/mm2, such as 0.5-2.5 N/mm², according to EN311. The adherence between the first wood veneer layer 1 and the core 11 may be at least 0.5 N/mm², such as at least 1 N/mm², according to EN311. The adherence between the first wood veneer layer 1 and the core 11 may be in the range of 0.5-10 N/mm2, such as 0.5-2.5 N/mm², according to EN311. The adherence between all layers may be at least 0.5 N/mm², such as at least 1 N/mm², according to EN311. The adherence between all layers may be in the range of 0.5-10 N/mm2, such as 0.5-2.5 N/mm², according to EN311.

After pressing in the second pressing step is the veneered panel 100 formed. The veneered panel 100 is shown in FIG. 5. The veneered panel 100 comprises the core 11 of the type described above with reference to FIG. 4, the veneer element 10 arranged on the first surface 12 of the core 11, and optionally the balancing layer arranged on the second surface 13 of the core 11, opposite the veneer element 10.

In the example shown in FIG. 5, the veneer element 10 comprises a plurality of second wood veneer layers 2a, 2b, 2c, 2d. As described above with reference to FIG. 3, the second wood veneers 2a, 2b, 2c, 2d may have different lengths and widths. In the example shown in FIG. 5, the second wood veneer layers 2a, 2b, 2c, 2d have different length. The second wood veneers 2a, 2b, 2c, 2d may be arranged with a gap between adjacent second wood veneers 2a, 2b 2c, 2d, or may be arranged such that no gap is present between adjacent second wood veneers 2a, 2b 2c, 2d.

The veneered panel 100 may be intended form an individual panel, or may be intended to be divided into several individual panels. The veneered panel 100 may be divided into individual panels along two adjacent second wood veneer layers 2a, 2b, 2c, 2d, or may be divided cross a second wood veneer layer 2. The veneered panel 100 may be a building panel, such as such as a floor panel, a wall panel, a furniture component, a building component, a worktop, etc. The veneered panel may be provided with a mechanical locking system, intended to join a building panel with another veneered panel.

### EXAMPLES

### Example 1

An aqueous solution comprising 50 wt % melamine formaldehyde and 50 wt % water was provided. To the aqueous solution 1 wt % of potato starch was added under stirring, wherein the weight percentage of starch is calculated on top of the 100 wt % aqueous solution.

A birch veneer having a thickness of 0.6 mm was provided. 150 g/m² of the aqueous binder solution comprising starch was applied on the birch veneer. A broncé oak veneer having a thickness of 0.55 mm and a nature grade oak veneer having a thickness of 0.4 mm were placed on the birch solution with the aqueous binder solution therebetween. The veneers were placed in a glue press a pressure of less than 15 bar was applied and the resin dried and a veneer element was formed without curing the melamine formaldehyde binder.

The starch content in the solution applied was too low to obtain the desired bonding of the veneers. The veneers separate quite easily after pressing.

### Example 2

An aqueous solution comprising 50 wt % melamine formaldehyde and 50 wt % water was provided. To the aqueous solution 2 wt % of potato starch was added under stirring, wherein the weight percentage of starch is calculated on top of the 100 wt % aqueous solution.

A birch veneer having a thickness of 0.6 mm was provided. 150 g/m² of the aqueous binder solution comprising starch was applied on the birch veneer. A broncé oak veneer having a thickness of 0.55 mm and a nature grade oak veneer having a thickness of 0.4 mm were placed on the birch solution with the aqueous binder solution therebetween. The veneers were placed in a glue press and a pressure of less than 15 bar was applied and the resin dried and a veneer element was formed without curing the melamine formaldehyde binder.

The binder solution thickened by the starch was easy to apply on the veneers and it had a reduced curling/bending on the veneers compared to binder solution without starch. The veneers hold together and was easy to handle prior to pressing.

### Example 3

An aqueous solution comprising 50 wt % melamine formaldehyde and 50 wt % water was provided. To the aqueous solution 3 wt % of potato starch was added under stirring, wherein the weight percentage of starch is calculated on top of the 100 wt % aqueous solution.

A birch veneer having a thickness of 0.6 mm was provided. 150 g/m² of the aqueous binder solution comprising starch was applied on the birch veneer. A broncé oak veneer having a thickness of 0.55 mm and a nature grade oak veneer having a thickness of 0.4 mm were placed on the birch solution with the aqueous binder solution therebetween. The veneers were placed in a glue press and a pressure of less than 15 bar was applied and the resin dried and a veneer element was formed without curing the melamine formaldehyde binder.

The binder solution thickened by the starch was easy to apply on the veneers and it had a reduced curling/bending on the veneers compared to binder solution without starch. The veneers hold together and was easy to handle prior to pressing.

### Example 4

An aqueous solution comprising 50 wt % melamine formaldehyde and 50 wt % water was provided. To the aqueous solution 4 wt % of potato starch was added under stirring, wherein the weight percentage of starch is calculated on top of the 100 wt % aqueous solution.

A birch veneer having a thickness of 0.6 mm was provided. 150 g/m² of the aqueous binder solution comprising starch was applied on the birch veneer. A broncé oak veneer having a thickness of 0.55 mm and a nature grade oak veneer having a thickness of 0.4 mm were placed on the birch solution with the aqueous binder solution therebetween. The veneers were placed in a glue press and a pressure of less than 15 bar was applied and the resin dried and a veneer element was formed without curing the melamine formaldehyde binder.

The binder solution thickened by the starch was easy to apply on the veneers and it had a reduced curling/bending on the veneers compared to binder solution without starch. The veneers hold together and was easy to handle prior to pressing

Example 5 An aqueous solution comprising 50 wt % melamine formaldehyde and 50 wt % water was provided. To the aqueous solution 5 wt % of potato starch was added under stirring, wherein the weight percentage of starch is calculated on top of the 100 wt % aqueous solution.

A birch veneer having a thickness of 0.6 mm was provided. 150 g/m² of the aqueous binder solution comprising starch was applied on the birch veneer. A broncé oak veneer having a thickness of 0.55 mm and a nature grade oak veneer having a thickness of 0.4 mm were placed on the birch solution with the aqueous binder solution therebetween. The veneers were placed in a glue press and a pressure of less than 15 bar was applied and the resin dried and a veneer element was formed.

The binder solution comprising 5 wt % was somewhat thick to be easily applied. The veneers hold together and was easy to handle prior to pressing.

### Example 6

The veneer elements produced according to examples 1-5 were arranged on HDF boards. Prior to applying the veneer elements on the HDF boards, a binder layer was applied in powder form in an amount of 150 g/m². The binder layer was comprising 52 wt % of melamine formaldehyde, 33.5 wt % of organic filler in form of wood fibres, 9.5 wt % inorganic filler in form of calcium carbonate, and 2.5 wt % pigments. The powder layer was stabilized with water and IR prior to applying the veneer elements.

The veneer elements according to example 1-5 was pressed to the HDF boards under the following press parameters:
Temperature: 180° C.
Pressure: 50 bar
Pressing time: 45 s

Pressing results in veneered panels having the desired appearance. Both the thin veneers (oak veneers) and the heat treated veneers (bronce veneers) work well when pressing in form of the veneer elements.

1. A method to produce a veneered panel,
providing a first wood veneer layer,
arranging at least one second wood veneer layer with a first binder layer comprising a first binder and starch, the first binder layer being applied intermediate the first wood veneer layer and said at least one second wood veneer layer,
pressing said at least one second wood veneer layer to the first wood veneer layer to form a veneer element in a first pressing step,
applying the veneer element on a core with a second binder layer comprising a second binder applied between the core and said at least one veneer element
pressing said at least one veneer element and the core together in a second pressing step,
wherein, in the second pressing step, the first binder and the second binder are cured to adhere the veneer element to the core to form a veneered panel.

2. The method according to claim 1, wherein, in the first pressing step, said at least one second wood veneer layer is adhered to the first wood veneer layer at least by the starch of the first binder layer.

3. The method according to claim 1, wherein, after the first pressing step, the first binder is substantially uncured.

4. The method according to claim 1, wherein pressure applied in the first pressing step is less than 15 bar.

5. The method according to claim 1, wherein pressure applied in the second pressing step exceeds 30 bar.

6. The method according to claim 1, wherein starch is applied in an amount of 1-10 g/m².

7. The method according to claim 1, wherein said at least one second wood veneer layer comprises a thermo-treated wood veneer.

8. The method according to claim 1, wherein said at least one second wood veneer layer has a porosity exceeding 50% as measured using mercury intrusion porosimetry.

9. The method according to claim 1, wherein said at least one second wood veneer layer has a thickness of less than of 0.6 mm.

10. The method according to claim 1, wherein said at least one second wood veneer layer has a thickness of less than of 0.4 mm.

11. The method according to claim 1, wherein said at least one second wood veneer layer is a sliced wood veneer.

12. The method according to claim 1, wherein the first wood veneer layer has a thickness of less than 1 mm.

13. The method according to claim 1, wherein the first wood veneer layer is a rotary cut wood veneer.

14. The method according to claim 1, wherein a plurality of second wood veneer layers is applied adjacent each other on the first wood veneer layer.

15. The method according to claim 14, wherein said plurality of second wood veneer layers are applied in a pattern on the first wood veneer layer.

16. The method according to claim 1, further comprising brushing said at least one second wood veneer layer after being adhered to the first wood veneer layer.

17. A veneered panel, comprising
a veneer element arranged on a core, wherein the veneer element comprises a first wood veneer layer and at a least a second wood veneer layer on the first wood veneer layer,
wherein said at least one second veneer layer is adhered to the first wood veneer layer by a first binder layer arranged between the first wood veneer layer and said at least one second wood veneer layer, the first binder layer comprising a first binder and starch, and
wherein the veneer element is adhered to the core by a second binder layer comprising a second binder.

18. A method to produce a veneer element, comprising
providing a first wood veneer layer,
arranging at least one second wood veneer layer with a first binder layer comprising a first binder and starch, the first binder layer being applied intermediate the first wood veneer layer and said at least one second wood veneer layer, wherein the first binder is an amino resin,
pressing said at least one second wood veneer layer to the first wood veneer layer to form a veneer element.

19. The method according to claim 18, wherein the first binder is substantially uncured after pressing.

20. The method according to claim 18, wherein said at least one second wood veneer layer is adhered to the first wood veneer layer at least by the starch of the first binder layer.

21. The method according to claim 18, wherein pressing is performed by applying a pressure of less than 15 bar.

22. The method according to claim 18, wherein starch is applied in an amount of 1-10 g/m².

23. The method according to claim 18, wherein the first binder is applied as an aqueous solution.

24. The method according to claim 18, wherein said at least one second wood veneer layer comprises a thermo-treated wood veneer.

25. The method according to claim 18, wherein said at least one second wood veneer layer has a porosity exceeding 50% as measured using mercury intrusion porosimetry.

26. The method according to claim 18, wherein said at least one second wood veneer layer as a thickness of less than of 0.6 mm.

27. The method according to claim 18, wherein said at least one second wood veneer layer has a thickness of less than of 0.4 mm.

28. The method according to claim 18, wherein said at least one second wood veneer layer is a sliced wood veneer.

29. The method according to claim 18, wherein the first wood veneer layer has a thickness of less than 1 mm.

30. The method according to claim 18, wherein the first wood veneer layer is a rotary cut wood veneer.

31. The method according to claim 18, wherein a plurality of said second wood veneer layers is applied adjacent each other on the first wood veneer layer.

32. The method according to claim 31, wherein said plurality of said second wood veneer layers are applied in a pattern on the first wood veneer layer.

33. The method according to claim 18, further comprising brushing said at least one second wood veneer layer after being adhered to the first wood veneer layer.

34. A veneer element, comprising
a first wood veneer layer,
at least one second wood veneer layer arranged on the first wood veneer layer, and
a first binder layer arranged between the first wood veneer layer and said at least one second wood veneer layer, the first binder layer comprising a first binder and starch, wherein the first binder is an amino resin,
wherein said at least one second wood veneer layer is adhered to the first wood veneer layer at least by the starch of the first binder layer, and wherein the first binder of the first binder layer is substantially uncured.
